(19) United States
(12) Patent Application Publication
(10) Pub. No.: US 2013/0126541 A1
(43) Pub. Date: May 23, 2013

(54) MAGNETIC ITEM HOLDER

(71) Applicant: AAW Products, Inc., Menlo Park, CA (US)

(72) Inventor: Andre A. Woolery, Menlo Park, CA (US)

(73) Assignee: AAW Products, Inc., Menlo Park, CA (US)

(21) Appl. No.: 13/739,702

(22) Filed: Jan. 11, 2013

Related U.S. Application Data
(63) Continuation-in-part of application No. 13/007,204, filed on Jan. 14, 2011.
(60) Provisional application No. 61/588,818, filed on Jan. 20, 2012.

(51) Int. Cl. B65D 23/00; G01B 3/10

(52) U.S. Cl. CPC B65D 23/003; G01B 3/1041
USPC 220/751; 29/428; 33/712

(57) ABSTRACT

A system for holding an item comprises a magnetic item comprising one or more magnets and a universal base comprising a magnetically attractable surface and for removably coupling with the magnetic item. In some embodiments, a shape of the one or more magnets is selected from a set comprising a strip, a ball bearing and a disc. In some embodiments, at least one of the one or more magnets comprise one or more of a neodymium magnet and a ceramic magnet. In further embodiments, the magnetic item is a holder comprising an aperture for receiving an additional item. In some embodiments, the universal base removably couples with an additional article. In some embodiments, the magnetic item is a tape measure. In further embodiments, the magnetic item and the universal base comprise interlocking geometry.

### RELATED APPLICATIONS

This patent application is a continuation-in-part of the co-pending U.S. patent application Ser. No. 13/007,204, filed Jan. 14, 2011 and entitled, “MAGNETIC TAPE MEASURE HOLDER,” which is hereby incorporated by reference in its entirety. This patent application also claims priority under 35 U.S.C. 119(e) of the co-pending U.S. Provisional patent application, Application No. 61/588,818, filed on Jan. 20, 2012, and entitled “MAGNETIC ITEM HOLDER,” which is also hereby incorporated by reference in its entirety.

### FIELD OF THE INVENTION

This invention relates generally to items incorporating magnets. More particularly, this invention relates to a magnetic item holder for magnetically securing the item to a magnetically attractable surface.

### BACKGROUND OF THE INVENTION

Small tools including, tape measures, levels, pliers, screw drivers, wrenches and others are an integral part of the professional and amateur tool kit. In particular, many projects require multiple tools to be used interchangeably throughout the course of the project. Tools not being used are typically placed on a tool bench or table and near the user for later use. However, because the tools are not secured, they may roll off of the tool bench or table and away from the user. Consequently, the user must stop what they are doing to look for the tools and take their eyes away from the project. This often leads to inefficiencies and time delays as the user must look for the proper tool and then focus back on the project in front of them.

Cell phone/smart phone devices are also tools which are used while working A cell phone/smart phone device and a Tablet PC is an easy and convenient way to correspond with team members and check project specifications. However, because cell phone/smart phone devices and Tablet PCs are less resilient than traditional tools they must be continuously monitored to ensure that they are not damaged.

### SUMMARY OF THE INVENTION

In one aspect, a tape measure comprises a body with a top, a bottom, and four sides, and one or more magnets embedded within and raised from an exterior the body. In some embodiments, the body comprises molded EVA plastic. In further embodiments, the body comprises one or more of metal and steel or a combination thereof. In some embodiments, the body comprises molded rubber. In some embodiments, the body further comprises a gripping portion. In some embodiments, a shape of the one or more magnets is selected from a set comprising a strip, a ball bearing and a disc. In further embodiments, at least one of the one or more magnets comprise one or more of a neodymium magnet and a ceramic magnet. In some embodiments, the one or more magnets are embedded into the plastic of the body. In further embodiments, the one or more magnets are embedded into the molded rubber of the body. In some embodiments, the one or more magnets are configured with interlocking geometry in order to removably couple with an interlocking base. In some embodiments, the one or more magnets are embedded within a raised surface of the body. In further embodiments, the body comprises a plurality of magnets.

In another aspect, a magnetic item holder comprises a body comprising an aperture that fits around an item in order to securely hold the item and one or more magnets coupled to the body for coupling the magnetic item holder and item to a magnetically attractable surface. In some embodiments, the item is a hand held tool. In further embodiments, the item is a cellular phone or smart phone device. In some of these embodiments, the one or more magnets coupled to the body are unidirectional magnets. In some embodiments, the magnetic item holder removably couples with a magnetically attractable surface. In some embodiments, the magnetic item holder comprises molded EVA plastic. In further embodiments, the magnetic item holder comprises any combination of leather, cotton, cotton/polyester blends, plastic, nylon, vinyl, neoprene, synthetic leather and/or rubber. In some embodiments, a shape of the one or more magnets is selected from a set comprising a strip, a ball bearing and a disc. In some embodiments, at least one of the one or more magnets comprise one or more of a neodymium magnet and a ceramic magnet.

In a further aspect, a system for holding an item comprises a magnetic item comprising one or more magnets and a universal base comprising a magnetically attractable surface and for removably coupling with the magnetic item. In some embodiments, a shape of the one or more magnets is selected from a set comprising a strip, a ball bearing and a disc. In some embodiments, at least one of the one or more magnets comprise one or more of a neodymium magnet and a ceramic magnet. In further embodiments, the magnetic item is a holder comprising an aperture for receiving an additional item. In some of these embodiments, the holder and the universal base comprise molded EVA plastic. In further embodiments, the holder and the universal base comprise any combination of leather, cotton, cotton/polyester blends, plastic, nylon, vinyl, neoprene, synthetic leather and/or rubber. In some embodiments, the universal base removably couples with an additional article. In some of these embodiments, the additional article is a belt. In further embodiments, the additional article is a tool belt. In still further embodiments, the additional article is a tool pouch of a tool belt. In some embodiments, the additional article is a tool box. In some embodiments, the magnetic item is a tape measure. In further embodiments, the magnetic item and the universal base comprise interlocking geometry.

In still a further aspect, a tape measure comprises a body with a top, a bottom, and four sides, and one or more magnets embedded within and raised from a raised exterior of the body.

In another aspect, a method of manufacturing a tape measure comprises manufacturing a tape measure body comprising a top, a bottom, and four sides, attaching one or more magnets with the tape measure body; and manufacturing a surface of the tape measure body around the one or more magnets, such that the one or more magnets are embedded within the surface. In some embodiments, the surface is a plastic surface. In further embodiments, the surface is a rubber surface. In some embodiments, the one or more magnets are embedded within a raised surface of the body.

### BRIEF DESCRIPTION OF THE DRAWINGS

FIG. 1A illustrates a front perspective view of a tape measure incorporating magnets in accordance with some embodiments.

FIG. 1B illustrates a back view of a tape measure incorporating magnets in accordance with some embodiments.

FIG. 2A illustrates a front view of a universal base for accepting a magnetic item holder in accordance with some embodiments.

FIG. 2B illustrates a back view of universal base for accepting a magnetic item holder in accordance with some embodiments.

FIGS. 3A and 3B illustrate the operation of a universal base in accordance with some embodiments.

FIGS. 4A and 4B illustrate a front view of a magnetic item holder in accordance with some embodiments.

FIG. 4C illustrates a back view of a magnetic item holder in accordance with some embodiments.

FIGS. 5A and 5B illustrate a front view of a magnetic item holder in accordance with some embodiments.

FIG. 5C illustrates a back view of a magnetic item holder in accordance with some embodiments.

FIG. 6A illustrates a front view of a magnetic item holder in accordance with some embodiments.

FIG. 6B illustrates a back view of a magnetic item holder in accordance with some embodiments.

FIGS. 7A and 7B illustrate the operation of a universal base in accordance with some embodiments.

### DETAILED DESCRIPTION OF THE INVENTION

In the following description, numerous details are set forth for purpose of explanation. However, one of ordinary skill in the art will realize that the invention may be practiced without the use of these specific details or with equivalent alternatives. Thus, the presently claimed invention is not intended to be limited to the embodiments shown but is to be accorded the widest scope consistent with the principles and features described herein. Throughout the description similar components are similarly marked in order to aid comprehension.

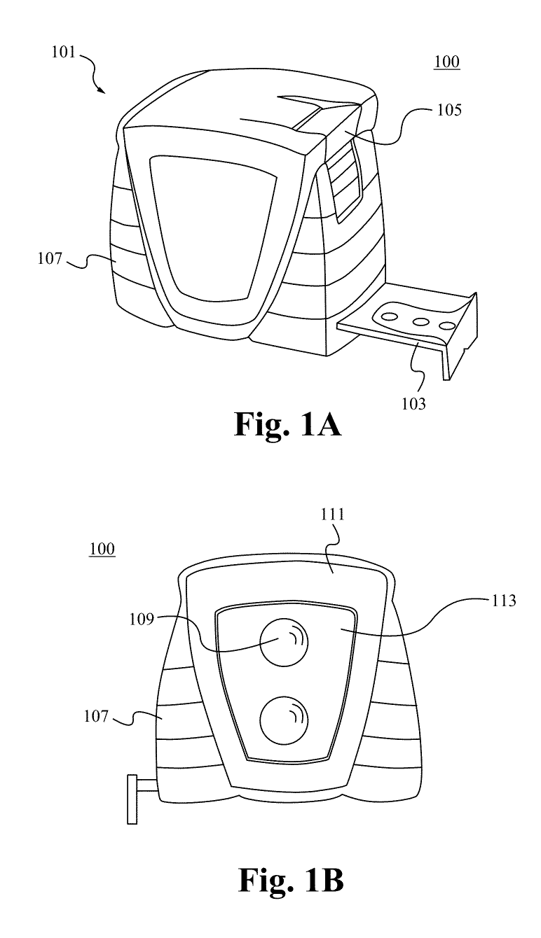

Referring now to FIG. 1A, a front view of a tape measure 100 is depicted therein. The tape measure 100 comprises a body 101 with a top, a bottom and four sides, a measuring tape 103, and a lever 105 for locking the measuring tape 103 in an extended position. In some embodiments, the body comprises molded EVA plastic. In some embodiments, the body comprises one or more of metal and steel or a combination thereof. As further shown in FIG. 1A, the tape measure comprises a grip 107. In some embodiments, the grip 107 is a co molded rubberized grip. In some embodiments, the grip 107 is a plastic grip. In some embodiments, the grip 107 is a raised portion of the body and surrounds the body 101 of the grip. However, as will be apparent to someone of ordinary skill in the art, the body 101 is able to be manufactured in any appropriate configuration.

FIG. 1B illustrates aback view of the tape measure 100 in accordance with some embodiments. As shown in FIG. 1B, the body 101 of the tape measure 100 comprises one or more magnets 109. In some embodiments, the one or more magnets 109 are embedded within the surface of the body 101. Particularly, the one or more magnets 109 are embedded within a surface of the body 101 such that a portion of the one or magnets 109 is above and below the surface. For example, in some embodiments, the one or more magnets 109 are attached to the body 101 and the surface of the tape measure is molded and/or manufactured around the one or more magnets 109. In some embodiments, the one or more magnets 109 are embedded within a plastic surface of the body 101. Alternatively, the one or more magnets 109 are embedded within a rubberized surface of the body 101. As will be apparent to someone of ordinary skill in the art, the one or more magnets 109 are able to be embedded in any portion of the body 101 of the tape measure 100. Particularly, as shown in FIG. 1B, the one or more magnets 109 are embedded within a raised exterior surface 113 of the body 101. In further embodiments, the one or more magnets 109 are embedded within a raised surface of the body 101. In some embodiments, the one or more magnets 109 are configured with interlocking geometry in order to interlock with and couple to a universal base that comprises a magnetically attractable surface. In some embodiments, the one or more magnets 109 are molded within and raised from an exterior casing of the body 101.

In some embodiments, at least one of the one or more magnets 109 comprises a neodymium magnet or a ceramic magnet. As will be evident to someone of ordinary skill in the art, the tape measure 100 is able to comprise any number and combination of magnets. For example, as shown in FIG. 1B, the tape measure 100 comprises a plurality of magnets. In some embodiments, a shape of the one or more magnets 109 is selected from a set comprising a strip, a ball bearing and a disc.

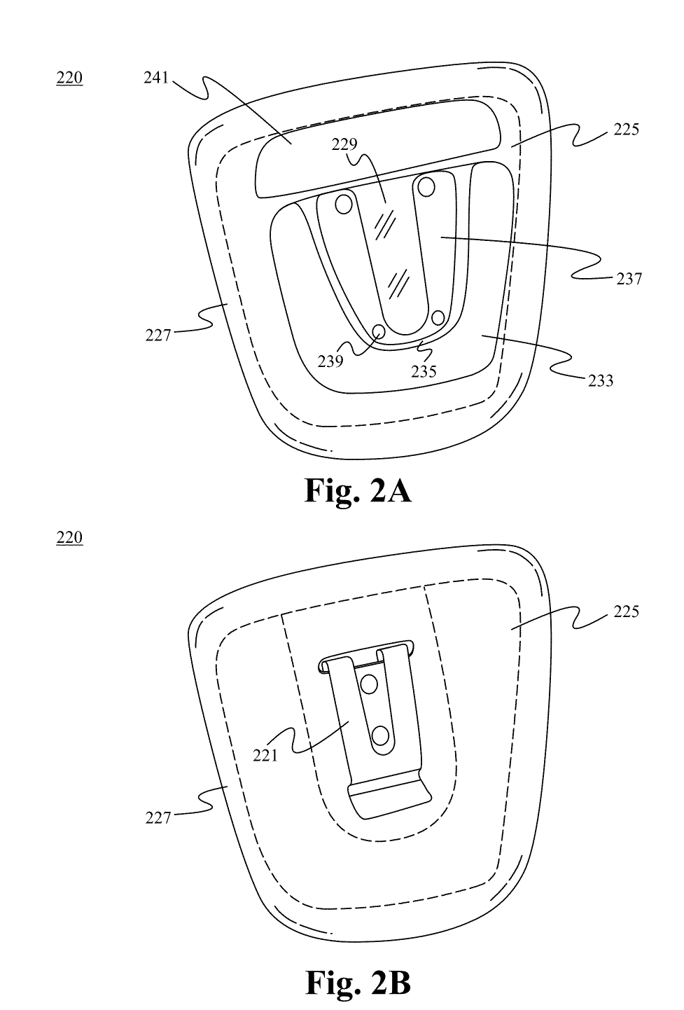

FIG. 2A shows a front view of a universal base in accordance with some embodiments. The universal base 220 comprises a receiver 235 and a magnetically attractable surface 229 for receiving a tape measure comprising magnets as described above. In some embodiments, the receiver 235 comprises a molded cavity and a raised edge 233 which interlocks with the tape measure and the magnets. As further described above, in some embodiments, the one or more magnets are embedded within a raised surface of the body of the tape measure. In these embodiments, the tape measure is able to be slid into the receiver 235 in order to removably couple the tape measure with the universal base 220. As shown in FIG. 2A, the raised edge 233 and the receiver 235 begin at the top of the universal base 220. Thus, when the magnetic item holder is slid into the receiver 235, the magnetic item holder is engaged by the receiver 235 and the raised edge 233 at the top of the universal base 220 and is held by the receiver 235 and the raised edge 233 as it is slid into the bottom of the receiver 235. The magnetic item holder is securely held within the receiver due to the interlocking geometry of the magnetic item holder and the universal base 220.

In some embodiments, the universal base 220 further comprises a magnetically attractable surface 229 for removably coupling with one or more of the magnets of the tape measure. In some embodiments, the magnetically attractable surface 229 comprises a steel plate. However, the magnetically attractable surface 229 is able to comprise any magnetic surface as known in the art. Thus, when the tape measure is slid into the receiver 235, the tape measure is engaged by the receiver 235 and the raised edge 233 and the one or more magnets of the tape measure removably couple with the magnetically attractable surface 229. In some embodiments, the universal base 220 only comprises a magnetically attractable surface 229. In these embodiments, the magnetic item holder is securely coupled to the universal base 220 by the attraction of the magnets 213 to the magnetically attractable surface 229. Alternatively, in some embodiments as described above, the tape measure is coupled to a magnetically attractable surface such as a toolbox, a steel beam, or other magnetically attractable surface. In some embodiments, the magnetically attractable surface 229 is surrounded by a binding 237 and one or more rivets 239.

In some embodiments, the universal base 220 comprises a surface 225 and a binding 227 surrounding the perimeter of the universal base 220. In some embodiments, the universal base 220 comprises one or more of a combination of leather, cotton, cotton/polyester blends, plastic, nylon, vinyl, neoprene, synthetic leather and/or rubber. In some embodiments, the binding 227 comprises molded EVA plastic. In some embodiments, the binding 227 comprises one or more of metal, plastic, and rubber.

FIG. 2B shows a back view of an universal base 220 in accordance with some embodiments. In some embodiments, the universal base 220 comprises a clip 221 for removably coupling with an additional article such as a belt. However, the universal base 220 is able to couple with an additional article by any mechanism as known in the art. For example, in some embodiments, the universal base 220 couples to an additional article by one or more of magnets and a hook and loop fastening system.

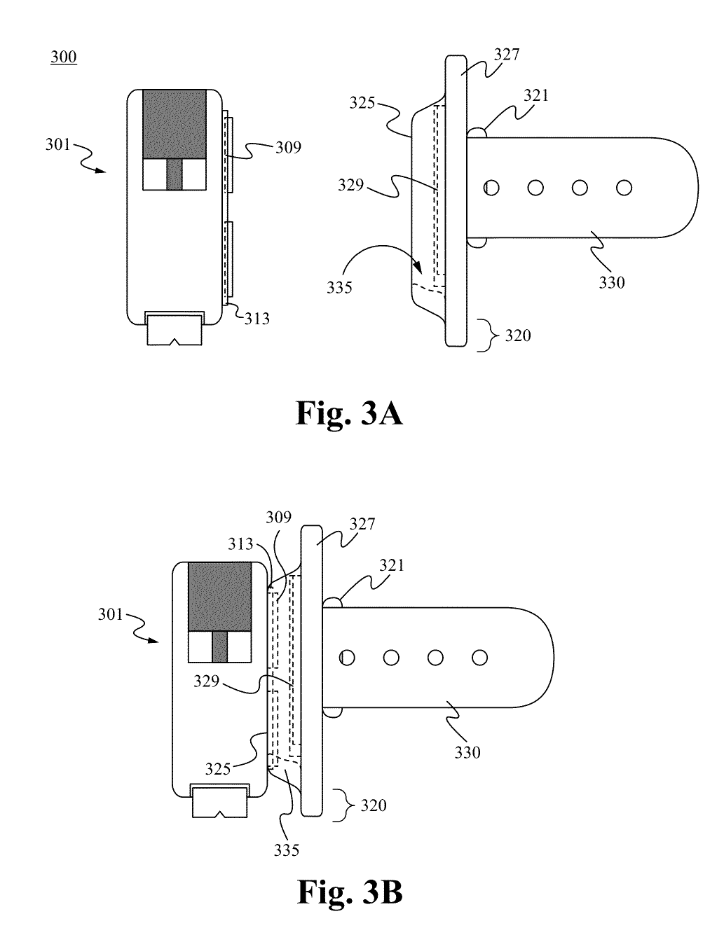

FIGS. 3A and 3B illustrate the operation of the universal base in accordance with some embodiments. As shown in FIG. 3A, the tape measure 300 comprises a body 301 with a top, a bottom, four sides, and one or more magnets 309 embedded within a surface of the body such that a portion of the one or magnets 309 is above and below the surface 313 of the body 301. As further shown in FIG. 3A and as described above, in some embodiments, the one or more magnets 309 are embedded within a raised exterior surface 313 of the body 301. In further embodiments, the one or more magnets 309 are embedded within a raised portion of the body 301. As further described above, in some embodiments, the body 301 comprises a plurality of magnets.

As also shown in FIG. 3A, the universal base 320 is removably coupled with a belt 330 by the clip 321. In some embodiments, the universal base 320 is removably coupled with a tool belt. In some embodiments, the magnetic item holder is coupled to one or more of a tool pouch, a tool box, and hangable apparatus. For example, in some embodiments the universal base 320 is coupled to an apparatus which is hung above a tool bench or other workspace.

The universal base 320 comprises a receiver 335, a raised edge 333 and a magnetically attractable surface 329. As shown in FIG. 3A, when the universal base 320 is coupled to an object such as a belt 330, the magnetically attractable surface 329, the receiver 335, and the raised edge 333 face outward. Accordingly, a user is able to slide the tape measure 300 into the receiver 335 and removably couple the one or more magnets 309 with the magnetically attractable surface 329. In some embodiments, the magnetic item holder 310 removably interlocks with a fitted cavity and the raised edge 333 of the universal base 320. Particularly, because the body 301 of the tape measure 300 incorporates magnets which are embedded within and raised from an exterior surface of the body 301, the tape measure 300 is able to securely attach to the magnetically attractable surface 329 without interference from the body 301 or other aspect of the tape measure 300. When the tape measure 300 is removably coupled with the universal base 320, the item is held close to the body or work area of the user where it is able to be quickly and conveniently accessed.

FIG. 3B illustrates the tape measure 300 removably coupled with the universal base 320 in accordance with some embodiments. As shown in FIG. 3B, when the tape measure 300 is placed within the receiver 335, the item is tightly held by the interlocking geometry of the tape measure, the raised surface 313 and the magnets 309 with the receiver 335 and the raised edge 333. Additionally, the one or more magnets 309 removably couple with the magnetically attractable surface 329. Consequently, in some embodiments, when the tape measure 300 is removably coupled with the universal base 320, the tape measure 300, is secured by two separate mechanisms. Thus, in order to remove the tape measure 300 from the universal base 320, the one or more magnets 309 are removed from the magnetically attractable surface 329 and the magnetic item holder 310 is removed from the receiver 335.

When using the tape measure 300, a user is able to couple the tape measure 300 with a magnetically attractable surface. For example, a user is able to removably couple the tape measure 300 with a tool box, steel beam, or other magnetically attractable surface. Alternatively, the tape measure is able to be removably coupled with the universal base 320. In either case, a user is able to keep the tape measure in a known place and within close reach while working. Additionally, as stated above, because the one or more magnets 309 are embedded within and raised from an exterior surface of the body 301, the tape measure 300 is able to securely attach to a magnetically attractable surface 329 without interference from the body 301 or other aspect of the tape measure 300. Moreover, because the one or more magnets 309 are molded into and/or embedded within the body 301, powerful neodymium and/or ceramic magnets are able to be used in order to securely hold and couple the tape measure 300 with the magnetically attractable surface.

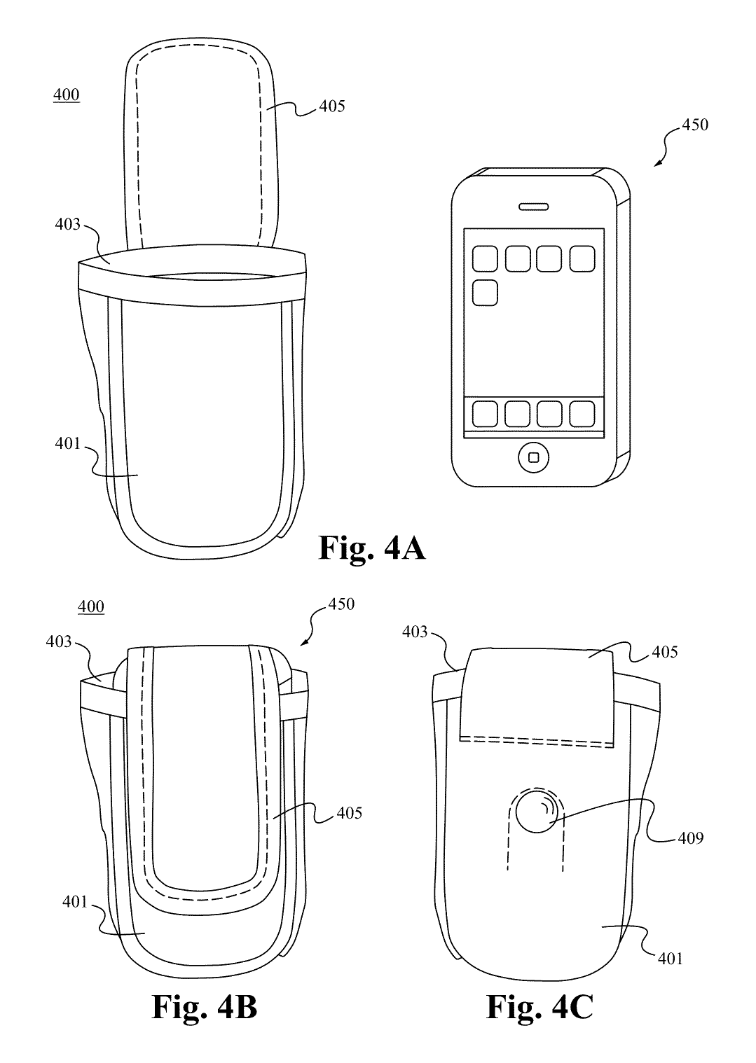

FIG. 4A shows a front view of a magnetic item holder 400 in accordance with further embodiments. The magnetic item holder 400 comprises a body 401 with a top, a bottom, four sides and an aperture 403. As shown in FIG. 4A, in some embodiments, the magnetic item holder further comprises a flap 405. The flap 405 is attached at one end to a top of the body 401 and folds over and removably couples with a front side of the body 401 in order to cover the aperture 403. In some embodiments, the flap 405 removably couples to the front side of the body 401 by one or more of a snap, a button, and a hook and loop fastening system. However, as will be apparent to someone of ordinary skill in the art, the flap 405 is able to removably couple with the body 401 by any appropriate mechanism as known in the art. In some embodiments, the magnetic item holder 400 comprises one or more of a combination of leather, cotton, cotton/polyester blends, plastic, nylon, vinyl, neoprene, synthetic leather and/or rubber. In some embodiments, the magnetic item holder 400 comprises molded EVA plastic. In some embodiments, the magnetic item holder 400 comprises one or more of metal, plastic, and rubber.

The body 401 of the magnetic item holder 400 is configured to accept and securely hold a cellular phone/smart phone device 450. In order to couple a cell phone/smart phone device 450 with the magnetic item holder 400, the cell phone/smart phone device 450 is inserted into the aperture 403 of the body 401. As shown in FIG. 4B, once the cell phone/smart phone device 450 has been inserted into the aperture 403, the flap 405 is folded over the aperture 403 and removably coupled with the body 401 and the cell phone/smart phone device is securely held within the body 401.

As shown in FIG. 4A and FIG. 4B, the aperture 403 is on a top of the body 401. However, the aperture 403 is able to be located at any position of the body 401. In some embodiments, the body 401 is stretchable and the aperture 403 is slightly smaller than a body of the cell phone/smart phone device 450. In these embodiments, the aperture 403 and the body 401 are stretched and widened in order to insert the cell phone/smart phone device 450 into the aperture 403. Once the cell phone/smart phone device has been inserted into the body 401, the aperture 403 and the body 401 returns to its original size in order to surround and snugly hold the cell phone/smart phone device. In further embodiments, the cell phone/smart phone device 450 is simply slid into the aperture 403 and securely held within the body 401 of the magnetic item holder 400. In still further embodiments, the magnetic item holder 400 comprises two pieces, which are press fit together in order to hold the cell phone/smart phone device.

FIG. 4C shows a back view of a magnetic item holder 400 in accordance with some embodiments. As shown in FIG. 4C, the magnetic item holder 400 comprises one or more magnets 409 coupled to a rear panel of the body 401. In some embodiments, the one or more magnets 409 are woven into the surface of the body 401. In some embodiments, at least one of the one or more magnets 409 comprises a neodymium magnet or a ceramic magnet. As will be evident to someone of ordinary skill in the art, the magnetic item holder 400 is able to comprise any number and combination of magnets. In some embodiments, a shape of the one or more magnets 409 is selected from a set comprising a strip, a ball bearing and a disc. In further embodiments, the one or magnets 409 comprise unidirectional magnets. In these embodiments, the unidirectional magnets magnetically attract in only one direction and do not interfere with the operation of the cell phone/smart phone device 450.

In some embodiments, the magnetic item holder 400 comprises one or more of a combination of leather, cotton, cotton/polyester blends, plastic, nylon, vinyl, neoprene, synthetic leather and/or rubber. In some embodiments, the body 401 comprises molded EVA plastic. In some embodiments, the body 401 comprises one or more of metal, plastic, and rubber. As shown in FIGS. 4A-4C, the body 401 in configured to hold a cell phone/smart phone device 450. However, as will be evident to someone of ordinary skill in the art, the body 401 is able to be sized to hold in appropriate object. For example, in some embodiments, the body 401 is manufactured in order to hold a Tablet PC or an Ereader.

When the cell phone/smart phone device 450 is placed within the aperture 403 and coupled with the body 401, a user is able to couple the magnetic item holder 400 containing the cell phone/smart phone device 450 with a magnetically attractable surface and keep the cell phone/smart phone device 450 close to the user without having hold the cell phone/smart phone device 450. For example, a user is able to safely secure the magnetic item holder 400 and the cell phone/smart phone device 450 to a magnetically attractable item while getting project instructions on a speaker phone, email, or the internet.

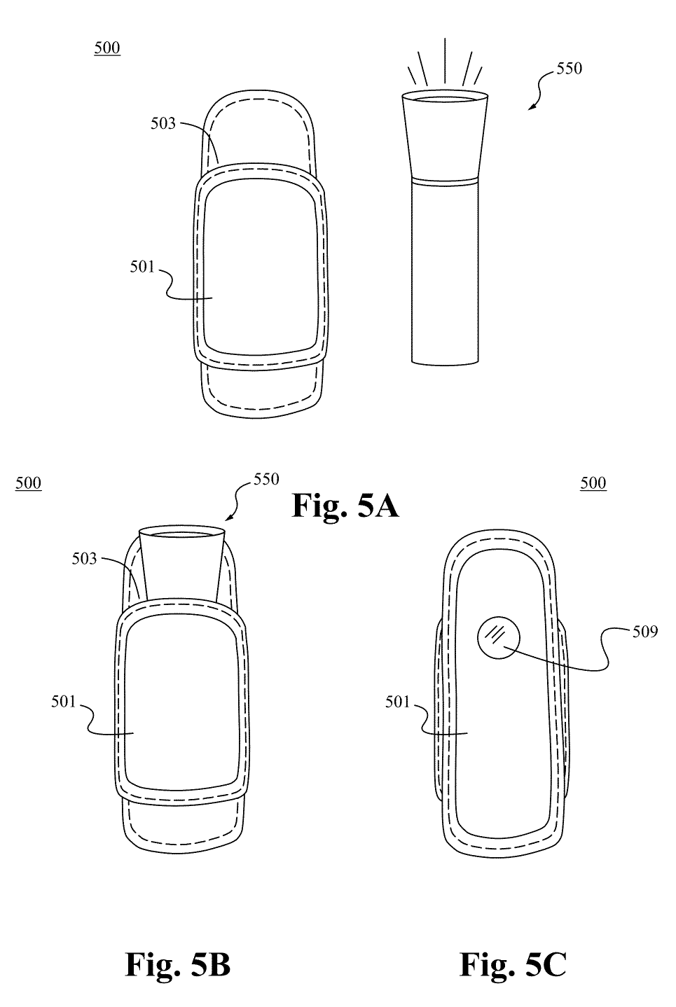

As will be evident to someone of ordinary skill in the art, the magnetic item holder is able to be designed in many different configurations in order to hold a variety of objects. FIG. 5A shows a front view of a magnetic item holder 500 in accordance with further embodiments. The magnetic item holder 500 comprises a body 501 with a top, a bottom, four sides and an aperture 503. As shown in FIG. 5A, in some embodiments, the aperture 503 is an open space near the top of the body 501. In some embodiments, the magnetic item holder 500 comprises one or more of a combination of leather, cotton, cotton/polyester blends, plastic, nylon, vinyl, neoprene, synthetic leather and/or rubber. In some embodiments, the magnetic item holder 500 comprises molded EVA plastic. In some embodiments, the magnetic item holder 500 comprises one or more of metal, plastic, and rubber.

The body 501 of the magnetic item holder 500 is configured to accept and securely hold a flashlight 550. In order to couple a flashlight 550 with the magnetic item holder 500, the flashlight 550 is inserted into the aperture 503 of the body 501. Particularly, in order to couple the flashlight 550 with the magnetic item holder 500, the flashlight is slid into the aperture 503 lengthwise. As shown in FIG. 5B, once the flashlight 550 has been inserted into the aperture 503, the flashlight 550 is securely held within the body 401.

As shown in FIG. 5A, the aperture 503 is on a top of the body 501. However, the aperture 503 is able to be located at any position of the body 501. In some embodiments, the body 501 is stretchable and the aperture 503 is slightly smaller than a body of the flashlight 550. In these embodiments, the aperture 503 and the body 501 are stretched and widened in order to insert the flashlight 550 into the aperture 503. Once the flashlight 550 has been inserted into the body 501, the aperture 503 and the body 501 returns to its original size in order to surround and snugly hold the cell phone/smart phone device. In further embodiments, the flashlight 550 is simply slid into the aperture 503 and securely held within the body 501 of the magnetic item holder 500.

FIG. 5C shows a back view of a magnetic item holder 500 in accordance with some embodiments. As shown in FIG. 5C, the magnetic item holder 500 comprises one or more magnets 509 coupled to a rear panel of the body 501. In some embodiments, the one or more magnets 509 are woven into the surface of the body 501. In some embodiments, at least one of the one or more magnets 509 comprises a neodymium magnet or a ceramic magnet. As will be evident to someone of ordinary skill in the art, the magnetic item holder 500 is able to comprise any number and combination of magnets. In some embodiments, a shape of the one or more magnets 509 is selected from a set comprising a strip, a ball bearing and a disc. In further embodiments, the one or magnets 509 comprise unidirectional magnets.

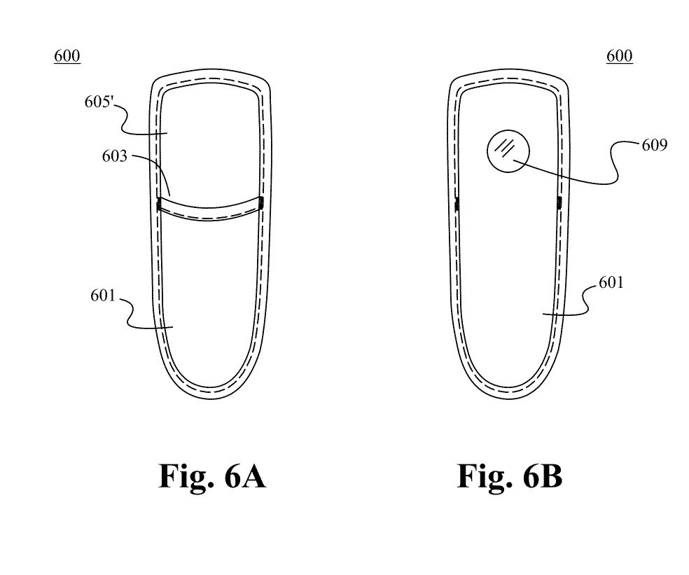

FIG. 6A shows a front view of a magnetic item holder 600 in accordance with yet further embodiments. The magnetic item holder 600 comprises a body 601 with a top, a bottom, four sides and an aperture 603. As shown in FIG. 603, in some embodiments, the aperture 603 is an open space near the top of the body 601. In some embodiments, the magnetic item holder 600 comprises one or more of a combination of leather, cotton, cotton/polyester blends, plastic, nylon, vinyl, neoprene, synthetic leather and/or rubber. In some embodiments, the magnetic item holder 600 comprises molded EVA plastic. In some embodiments, the magnetic item holder 600 comprises one or more of metal, plastic, and rubber.

The body 601 of the magnetic item holder 600 is configured to accept an securely hold a small hand held tool. In order to couple the tool with the magnetic item holder 600, the tool is inserted into the aperture 603 of the body 601. Particularly, in order to couple the tool with the magnetic item holder 600, the tool is slid into the aperture 603 lengthwise. As further shown in FIG. 6A, the body 601 comprises an extension 605′, which extends upwards from the aperture 603. In some embodiments, when a tool is held within the aperture 603, a portion of the tool extends out from the aperture 603 and rests against the extension 605′. For example, in some embodiments, a pair of pliers is removably coupled with the magnetic item holder 600. In these embodiments, the head portion of the pliers is inserted into and held within the aperture 603 while the grip portion extends out from and rests against the extension 605′. Thus, a user is able to easily grasp the grip portion in order to insert the pliers into or remove the pliers from the aperture 603. As will be apparent to someone of ordinary skill in the art, any appropriate hand held tool is able to be coupled with the magnetic item holder 600. For example, in some embodiments, a level, a wrench, a screwdriver, a chisel, a putty knife, or a stud finder is held by the magnetic item holder 600.

As further shown in FIG. 6A, the aperture 603 is on a top of the body 601. However, the aperture 603 is able to be located at any position of the body 601. In some embodiments, the body 601 is stretchable and the aperture 603 is slightly smaller than a body of a hand tool. In these embodiments, the aperture 603 and the body 601 are stretched and widened in order to insert the hand tool into the aperture 603. Once the hand tool has been inserted into the body 601, the aperture 603 and the body 601 returns to its original size in order to surround and snugly hold the cell phone/smart phone device. In further embodiments, the hand tool is simply slid into the aperture 603 and securely held within the body 601 of the magnetic item holder 600.

FIG. 6B shows a back view of a magnetic item holder 600 in accordance with some embodiments. As shown in FIG. 6C, the magnetic item holder 600 comprises one or more magnets 609 coupled to a rear panel of the body 601. In some embodiments, the one or more magnets 609 are woven into the surface of the body 601. In some embodiments, at least one of the one or more magnets 609 comprises a neodymium magnet or a ceramic magnet. As will be evident to someone of ordinary skill in the art, the magnetic item holder 600 is able to comprise any number and combination of magnets. In some embodiments, a shape of the one or more magnets 609 is selected from a set comprising a strip, a ball bearing and a disc. In further embodiments, the one or magnets 609 comprise unidirectional magnets.

In some embodiments, the magnetic item holders as described above are able to couple with a universal base which comprises a magnetically attractable surface as described in relation to FIGS. 2A and 2B.

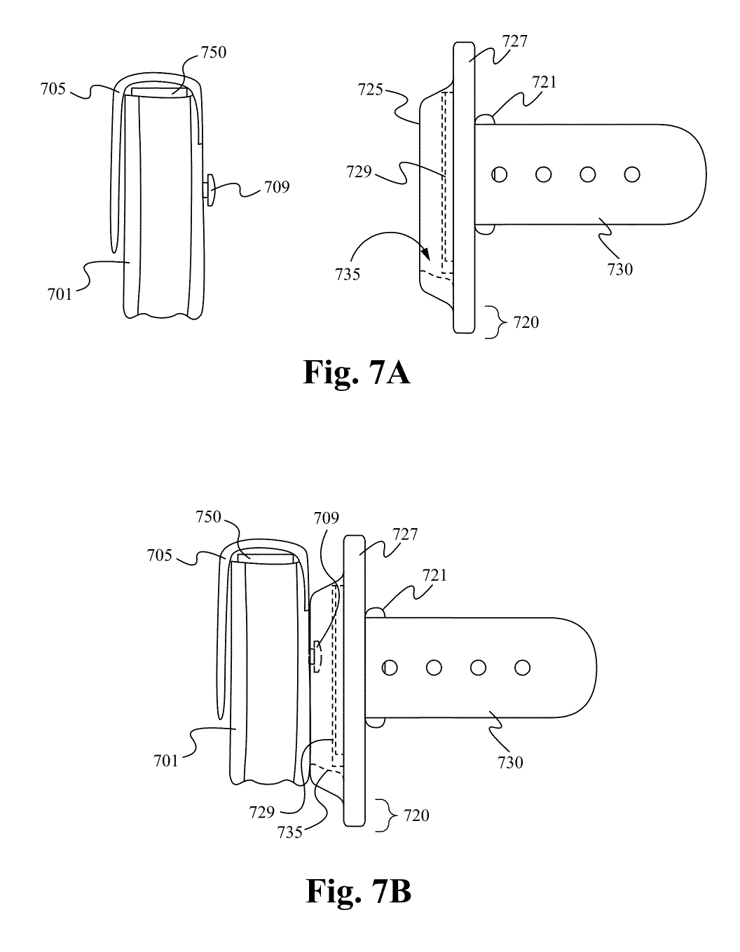

FIGS. 7A and 7B illustrate the operation of the universal base in accordance with some embodiments. As shown in FIG. 7A, the magnetic item holder 700 is the magnetic item holder 400 as described in relation to FIGS. 4A-4C. The magnetic item holder 700 comprises a body 701 with a top, a bottom, four sides, an aperture 703, and a flap 705. The magnetic item holder 700 is shown holding a cell phone/smart phone device 750.

As also shown in FIG. 7A, the universal base 720 is removably coupled with a belt 730 by the clip 721. In some embodiments, the universal base 720 is removably coupled with a tool belt. In some embodiments, the magnetic item holder is coupled to one or more of a tool pouch, a tool box, and hangable apparatus. For example, in some embodiments the universal base 720 is coupled to an apparatus which is hung above a tool bench or other workspace.

The universal base 720 comprises a receiver 735, a raised edge 733 and a magnetically attractable surface 729. As shown in FIG. 7A, when the universal base 720 is coupled to an object such as a belt 730, the magnetically attractable surface 729, the receiver 735, and the raised edge 733 face outward. Accordingly, a user is able to slide the magnetic item holder 700 into the receiver 735 and removably couple the one or more magnets 709 with the magnetically attractable surface 729. In some embodiments, the magnetic item holder 700 removably interlocks with a fitted cavity and the raised edge 733 of the universal base 720. When the magnetic item holder 700 is removably coupled with the universal base 720, the item is held close to the body or work area of the user where it is able to be quickly and conveniently accessed.

FIG. 7B illustrates the magnetic item holder 700 with the cell phone/smart phone device 450 removably coupled with a universal base 720 in accordance with some embodiments. As shown in FIG. 7B, when the magnetic item holder 700 is placed within the receiver 735, the item is tightly held by the interlocking geometry of the magnetic item holder 700 with the receiver 735 and the raised edge 733. Additionally, the one or more magnets 709 removably couple with the magnetically attractable surface 729. Consequently, when magnetic item holder 700 is removably coupled with the universal base 720, the magnetic item holder 700, is secured by two separate mechanisms. Thus, in order to remove the magnetic item holder 700 from the universal base 720, the one or more magnets 709 are removed from the magnetically attractable surface 729 and the magnetic item holder 700 is removed from the receiver 735.

Using a magnetic item holder in conjunction with a universal base enables a user to keep a variety of hand tools near to the user for easy access and use. For example, a user is able to remove the magnetic item holder 700 containing a cell phone/smart phone device 750 from the universal base in order to make an important call without having to move from the workspace. Alternatively, a user is able to removably couple the magnetic item holder containing a hand tool with a nearby magnetically attractable surface in order to free up space and remove clutter, while still keeping the hand tool nearby. Particularly, the magnetic item holder enables a user to freely complete a work project without misplacing tools cluttering the work area.

Additionally, in use, the tape measure incorporating magnets and the magnetic item holder enable a user to add magnets to a previously non-magnetic item and couple the item with a magnetically attractable surface. Additionally, the magnetic item holder is able to couple the item with a universal base. When coupled with the universal base, the item is closely and securely held a by two separate mechanisms.

In one instance, the magnetic item holder is securely held within the universal base due to the interlocking geometry of the magnetic item holder and the universal base. In a second instance, the magnetic item holder is held in place due to the attraction of magnets of the holder with a magnetically attractable surface of the universal base. In doing so a user is able to secure an item without having to worry about the item moving or being damaged by an additional item. Accordingly, the multiple magnetic item holders are interchangeable and compatible with the universal base. Further, in another embodiment, by incorporating magnets directly with an outer body of an item, the item is able to couple with a magnetically attractable surface without additional modification. Thus, the magnetic item holder and outer body as described above have many advantages.

The invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications area able to be made in the embodiment chosen for illustration without departing from the spirit and scope of the invention. Specifically, it will be apparent that the design for the magnetic tape measure holder is able to be implemented with many different tool holders as known in the art. Further, it will be apparent to one of ordinary skill in the art that the precise structure of the device is able to be substantially varied to accommodate various magnetically attractable materials and configurations of magnets. Consequently, the claims should be broadly construed, consistent with the spirit and scope of the invention, and should not be limited to their exact, literal meaning.

We claim:

1. A tape measure, comprising:
a. a body with a top, a bottom, and four sides; and
b. one or more magnets embedded within and raised from an exterior of the body.

2. The tape measure of claim 1, wherein the body comprises molded EVA plastic.

3. The tape measure of claim 1, wherein the body comprises one or more of metal and steel or a combination thereof.

4. The tape measure of claim 1, wherein the body further comprises a gripping portion.

5. The tape measure of claim 1, wherein the body comprises molded rubber.

6. The tape measure of claim 1, wherein a shape of the one or more magnets is selected from a set comprising a strip, a ball bearing and a disc.

7. The tape measure of claim 1, wherein at least one of the one or more magnets comprise one or more of a neodymium magnet and a ceramic magnet.

8. The tape measure of claim 1, wherein the one or more magnets are embedded into the plastic of the body.

9. The tape measure of claim 1, wherein the one or more magnets are embedded into the molded rubber of the body.

10. The tape measure of claim 1, wherein the one or more magnets are configured with interlocking geometry in order to removably couple with an interlocking base.

11. The tape measure of claim 1, wherein the one or more magnets are embedded within a raised surface of the body.

12. The tape measure of claim 1, wherein the body comprises a plurality of magnets.

13. A magnetic item holder, comprising:
a. a body comprising an aperture that fits around an item in order to securely hold the item; and
b. one or more magnets coupled to the body for coupling the magnetic item holder and item to a magnetically attractable surface.

14. The magnetic item holder of claim 13, wherein the item is a hand held tool.

15. The magnetic item holder of claim 13, wherein the item is a cellular phone or smart phone device.

16. The magnetic item holder of claim 15, wherein the one or more magnets coupled to the body are unidirectional magnets.

17. The magnetic item holder of claim 13, wherein the magnetic item holder removably couples with a magnetically attractable surface.

18. The magnetic item holder of claim 13, wherein the magnetic item holder comprises molded EVA plastic.

19. The magnetic item holder of claim 13, wherein the magnetic item holder comprises any combination of leather, cotton, cotton/polyester blends, plastic, nylon, vinyl, neoprene, synthetic leather and/or rubber.

20. The magnetic item holder of claim 13, wherein a shape of the one or more magnets is selected from a set comprising a strip, a ball bearing and a disc.

21. The magnetic item holder of claim 13, wherein at least one of the one or more magnets comprise one or more of a neodymium magnet and a ceramic magnet.

22. A system for holding an item, comprising:
a. a magnetic item comprising one or more magnets; and
b. a universal base comprising a magnetically attractable surface and for removably coupling with the magnetic item.

23. The system of claim 22, wherein a shape of the one or more magnets is selected from a set comprising a strip, a ball bearing and a disc.

24. The system of claim 22, wherein at least one of the one or more magnets comprise one or more of a neodymium magnet and a ceramic magnet.

25. The system of claim 22, wherein the magnetic item is a holder comprising an aperture for receiving an additional item.

26. The system of claim 25, wherein the holder and the universal base comprise molded EVA plastic.

27. The system of claim 25, wherein the holder and the universal base comprise any combination of leather, cotton, cotton/polyester blends, plastic, nylon, vinyl, neoprene, synthetic leather and/or rubber.

28. The system of claim 22, wherein the universal base removably couples with an additional article.

29. The system of claim 28, wherein the additional article is a belt.

30. The system of claim 28, wherein the additional article is a tool belt.

31. The system of claim 28, wherein the additional article is a tool pouch of a tool belt.

32. The system of claim 28, wherein the additional article is a tool box.

33. The system of claim 22, wherein the magnetic item is a tape measure.

34. The system of claim 22, wherein the magnetic item and the universal base comprise interlocking geometry.

35. A tape measure, comprising:
a. a body with a top, a bottom, and four sides; and
b. one or more magnets embedded within and raised from a raised exterior of the body.

36. A method of manufacturing a tape measure, comprising:
a. manufacturing a tape measure body comprising a top, a bottom, and four sides;
b. attaching one or more magnets with the tape measure body; and
c. manufacturing a surface of the tape measure body around the one or more magnets, such that the one or more magnets are embedded within the surface.

37. The method of claim 36 wherein the surface is a plastic surface.

38. The method of claim 36 wherein the surface is a rubber surface.

39. The method of claim 36 wherein the one or more magnets are embedded within a raised surface of the body.
